(19) United States
(12) Patent Application Publication
(10) Pub. No.: US 2003/0197319 A1
(43) Pub. Date: Oct. 23, 2003

(54) Vise

(76) Inventor: Yun-Fu Ho, Taichung (TW)

Correspondence Address: Yun-Fu Ho, 58, MA YUAN WEST ST., TAICHUNG, TW

(21) Appl. No.: 10/132,901

(22) Filed: Apr. 23, 2002

(51) Int. Cl. B25B 1/10

(52) U.S. Cl. 269/246

(57) ABSTRACT

A vise has a first clamp seat, a second clamp seat engaging with the first clamp seat, a first clamp plate fastened on the first clamp seat, a second clamp plate fastened on the second clamp seat, a taper block disposed between the first clamp seat and the second clamp seat, a taper collar disposed on the taper block, a pair of coiled springs, a pair of fastening bolts, an adjustment bolt, and a nut. The first clamp seat has an inclined face, a notch, a recessed face, and a pair of through holes. The second clamp seat has an inclined face, a notch, a recessed face, and a pair of threaded apertures. The taper block has an oblong hole. The coiled springs are inserted in the through holes of the first clamp seat. The fastening bolts pass through the coiled springs to fasten the first clamp seat and the second clamp seat together. The adjustment bolt pass through the taper collar and the taper block. The nut engages with the adjustment bolt.

### BACKGROUND OF THE INVENTION

The present invention relates to a vise. More particularly, the present invention relates to a vise which clamps a working article stably.

Referring to FIGS. 1 and 2, a conventional vise 1 has a first jaw 101 and a second jaw 102 to clamp a working article 2. When the first jaw 101 and the second jaw 102 tighten the working article 2 to the utmost, the working article 2 will be moved upward.

### SUMMARY OF THE INVENTION

An object of the present invention is to provide a vise which clamps a working article stably so that the working article will not move upward.

Accordingly, a vise comprises a first clamp seat, a second clamp seat engaging with the first clamp seat, a first clamp plate fastened on the first clamp seat, a second clamp plate fastened on the second clamp seat, a taper block disposed between the first clamp seat and the second clamp seat, a taper collar disposed on the taper block, a pair of coiled springs inserted in the first clamp seat, a pair of fastening bolts passing through the coiled springs to fasten the first clamp seat and the second clamp seat together, an adjustment bolt passing through the taper collar and the taper block, and a nut engaging with the adjustment bolt.

In accordance with a first preferred embodiment of the present invention, a vise comprises a first clamp seat, a second clamp seat engaging with the first clamp seat, a first clamp plate fastened on the first clamp seat, a second clamp plate fastened on the second clamp seat, a taper block disposed between the first clamp seat and the second clamp seat, a taper collar disposed on the taper block, a pair of coiled springs, a pair of fastening bolts, a pair of compression springs, a pair of fastening tubes, an adjustment bolt, and a nut. The first clamp seat has an inclined face, a pair of slant faces, a notch, a pressing face, an upper face, a recessed face, and a pair of through holes. The second clamp seat has an inclined face, a pair of slant faces, a notch, a pressing face, an upper face, a recessed face, and a pair of threaded apertures. The taper block has an oblong hole, a first taper face, a second taper face, and four corner taper faces. The taper collar has a center hole. The coiled springs are inserted in the through holes of the first clamp seat. The fastening bolts pass through the coiled springs to fasten the first clamp seat and the second clamp seat together. The compression springs are inserted in the through apertures of the second clamp seat. The fastening tubes pass through the compression springs to fasten the first clamp seat and the second clamp seat together. The fastening bolts engage with the fastening tubes. The adjustment bolt pass through the taper collar and the taper block. The nut engages with the adjustment bolt.

In accordance with a second preferred embodiment of the present invention, a vise comprises a first clamp seat, a second clamp seat engaging with the first clamp seat, a first clamp plate fastened on the first clamp seat, a second clamp plate fastened on the second clamp seat, a taper block disposed between the first clamp seat and the second clamp seat, a taper collar disposed on the taper block, a pair of coiled springs, a pair of fastening bolts, an adjustment bolt, and a nut. The first clamp seat has an inclined face, a pair of slant faces, a notch, a pressing face, an upper face, a recessed face, and a pair of through holes. The second clamp seat has an inclined face, a pair of slant faces, a notch, a pressing face, an upper face, a recessed face, and a pair of threaded apertures. The taper block has an oblong hole, a first taper face, a second taper face, and four corner taper faces. The taper collar has a center hole. The coiled springs are inserted in the through holes of the first clamp seat. The fastening bolts pass through the coiled springs to fasten the first clamp seat and the second clamp seat together. The adjustment bolt pass through the taper collar and the taper block. The nut engages with the adjustment bolt.

In accordance with a third preferred embodiment of the present invention, a vise comprises a first clamp seat, a second clamp seat engaging with the first clamp seat, a first clamp plate fastened on the first clamp seat, a second clamp plate fastened on the second clamp seat, a taper block disposed between the first clamp seat and the second clamp seat, a taper collar disposed on the taper block, a pair of coiled springs, a pair of fastening bolts, an adjustment bolt, and a nut. The first clamp seat has an inclined face, a notch, a pressing face, an upper face, a recessed face, and a pair of through holes. The second clamp seat has an inclined face, a notch, a pressing face, an upper face, a recessed face, and a pair of threaded apertures. The taper block has an oblong hole, a first taper face, a second taper face, and four corner taper faces. The taper collar has a center hole. The coiled springs are inserted in the through holes of the first clamp seat. The fastening bolts pass through the coiled springs to fasten the first clamp seat and the second clamp seat together. The adjustment bolt pass through the taper collar and the taper block. The nut engages with the adjustment bolt.

In accordance with a fourth preferred embodiment of the present invention, a vise comprises a first clamp seat, a second clamp seat engaging with the first clamp seat, a first camber plate fastened on the first clamp seat, a second camber plate fastened on the second clamp seat, a taper block disposed between the first clamp seat and the second clamp seat, a taper collar disposed on the taper block, a pair of coiled springs, a pair of fastening bolts, a pair of compression springs, a pair of fastening tubes, an adjustment bolt, and a nut. The first clamp seat has an inclined face, a pair of slant faces, a notch, a pressing face, an upper face, a camber recess, and a pair of through holes. The second clamp seat has an inclined face, a pair of slant faces, a notch, a pressing face, an upper face, a camber recess, and a pair of threaded apertures. The taper block has an oblong hole, a first taper face, a second taper face, and four corner taper faces. The taper collar has a center hole. The coiled springs are inserted in the through holes of the first clamp seat. The fastening bolts pass through the coiled springs to fasten the first clamp seat and the second clamp seat together. The adjustment bolt pass through the taper collar and the taper block. The nut engages with the adjustment bolt.

### BRIEF DESCRIPTION OF THE DRAWINGS

FIG. 1 is a perspective view of a conventional vise of the prior art;

FIG. 2 is a schematic view illustrating an application of a conventional vise of the prior art;

FIG. 3 is a perspective exploded view of a vise of a first preferred embodiment in accordance with the present invention;

FIG. 3A is a partially perspective view of a through hole of a first clamp seat of a first preferred embodiment in accordance with the present invention;

FIG. 3B is a partially perspective view of a through aperture of a second clamp seat of a first preferred embodiment in accordance with the present invention;

FIG. 4 is a sectional schematic view illustrating an adjustment bolt of a first preferred embodiment is not tightened;

FIG. 4A is a sectional view taken along line 4A-4A in FIG. 4;

FIG. 5 is a sectional schematic view illustrating an adjustment bolt of a first preferred embodiment is tightened;

FIG. 6 is an elevational schematic view illustrating an adjustment bolt of a first preferred embodiment is not tightened;

FIG. 7 is an elevational schematic view illustrating an adjustment bolt of a first preferred embodiment is tightened;

FIG. 8 is a perspective exploded view of a vise of a second preferred embodiment in accordance with the present invention;

FIG. 8A is a partially perspective view of a through hole of a first clamp seat of a second preferred embodiment in accordance with the present invention;

FIG. 9 is a sectional schematic view illustrating an adjustment bolt of a second preferred embodiment is not tightened;

FIG. 9A is a sectional view taken along line 9A-9A in FIG. 9;

FIG. 10 is a sectional schematic view illustrating an adjustment bolt of a second preferred embodiment is tightened;

FIG. 11 is an elevational schematic view illustrating an adjustment bolt of a second preferred embodiment is not tightened;

FIG. 12 is an elevational schematic view illustrating an adjustment bolt of a second preferred embodiment is tightened;

FIG. 13 is a perspective exploded view of a vise of a third preferred embodiment in accordance with the present invention;

FIG. 14 is a sectional schematic view illustrating an adjustment bolt of a third preferred embodiment is not tightened;

FIG. 14A is a sectional view taken along line 14A-14A in FIG. 14; and

FIG. 15 is a perspective exploded view of a vise of a fourth preferred embodiment in accordance with the present invention.

### DETAILED DESCRIPTION OF THE INVENTION

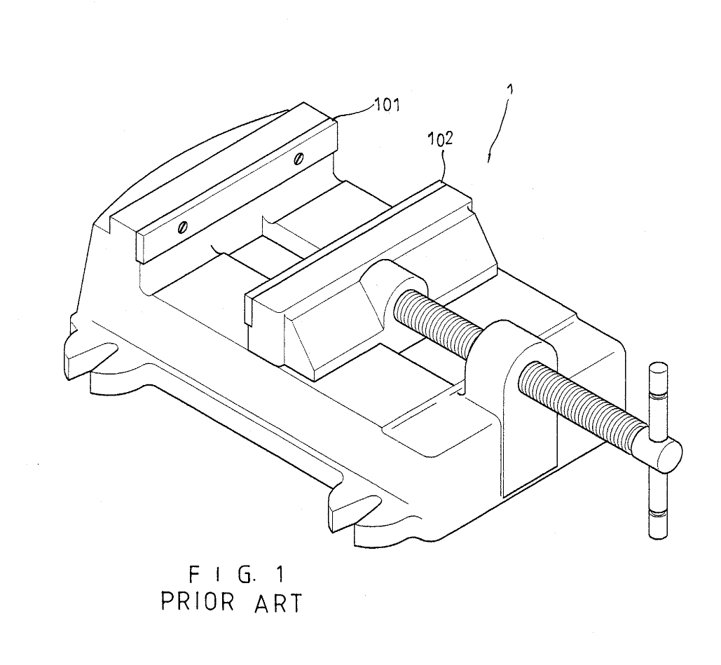

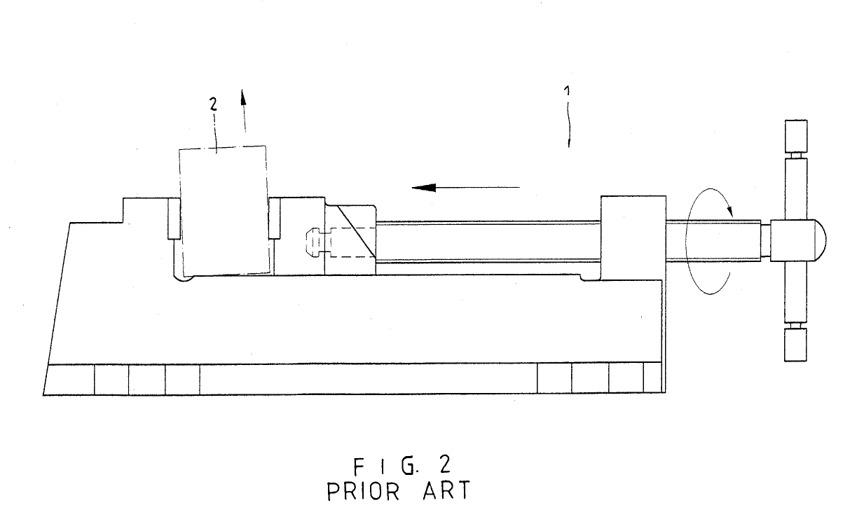

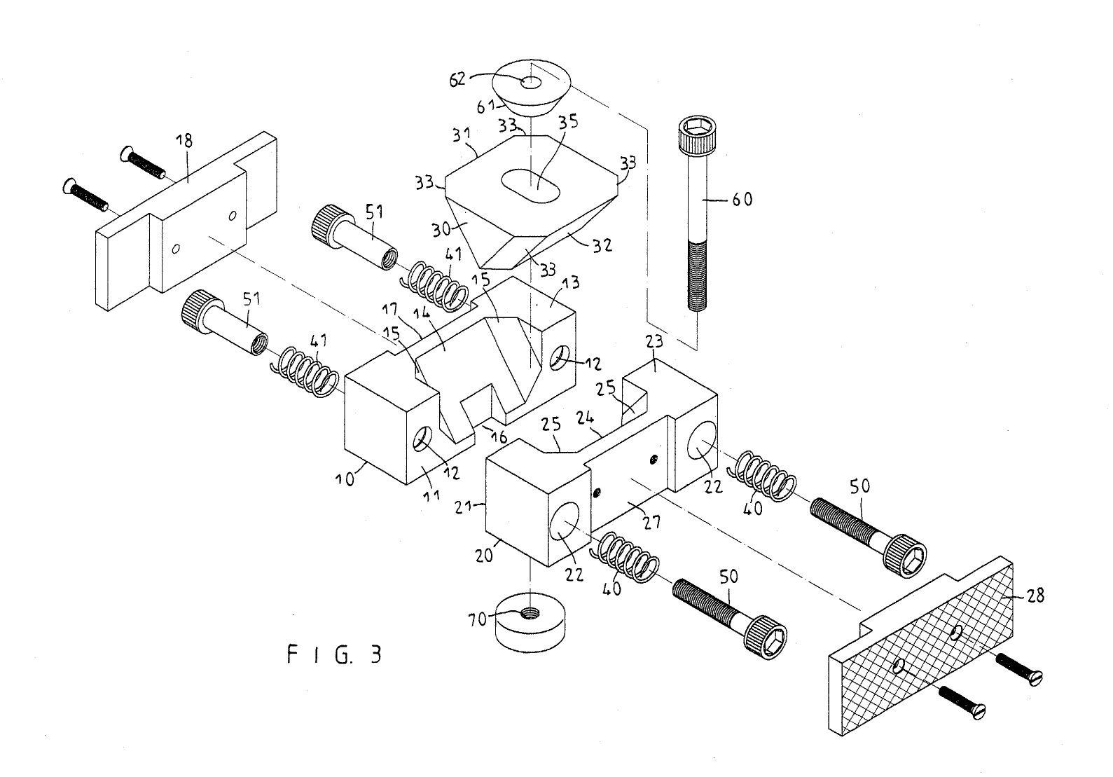

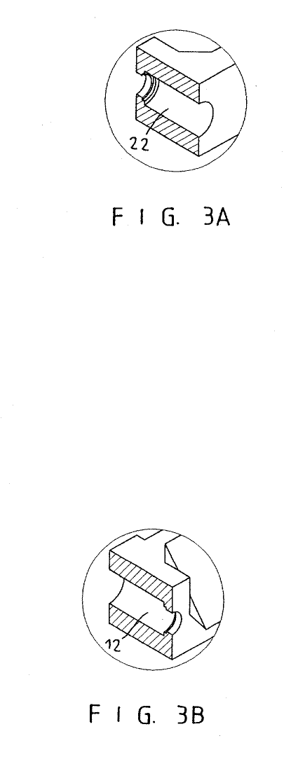

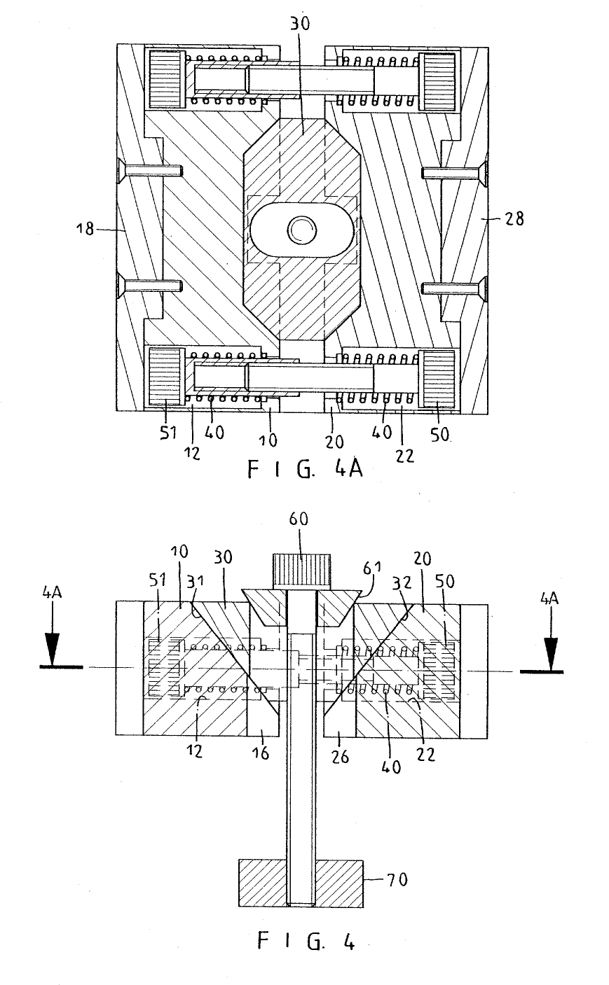

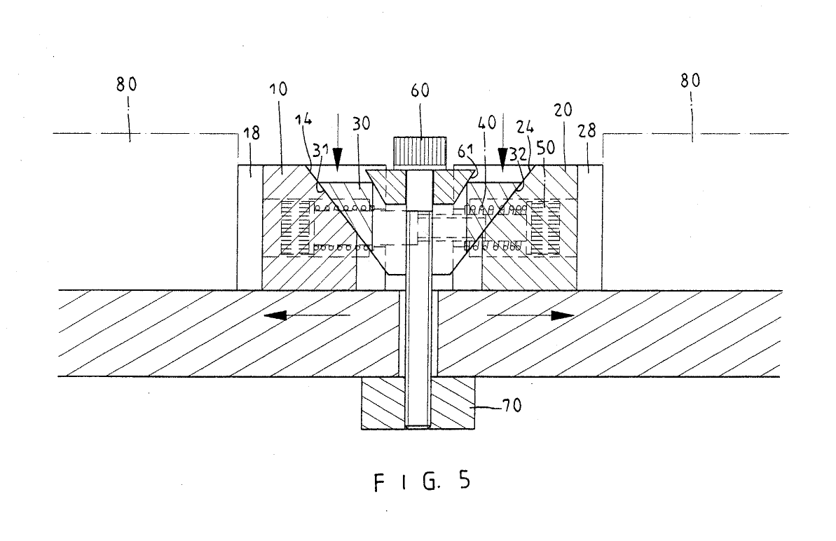

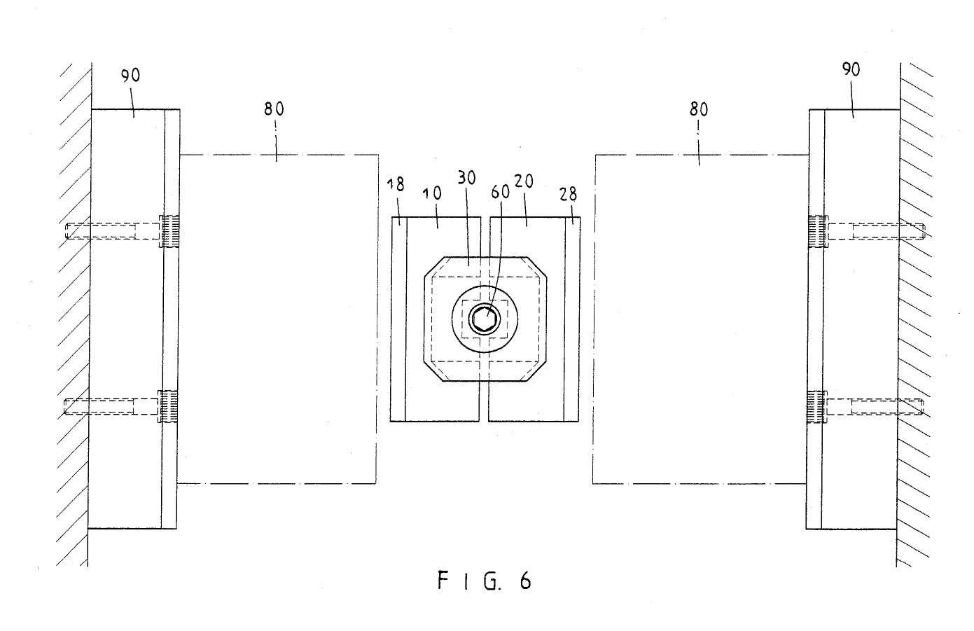

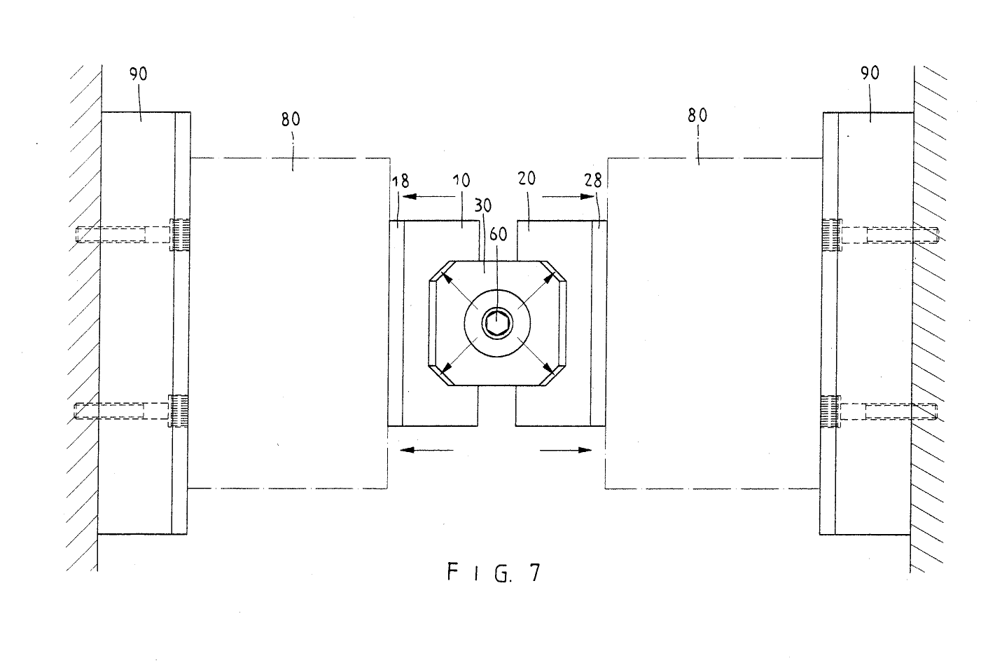

Referring to FIGS. 1 to 7, a first vise comprises a first clamp seat 20, a second clamp seat 10 engaging with the first clamp seat 20, a first clamp plate 28 fastened on the first clamp seat 20, a second clamp plate 18 fastened on the second clamp seat 10, a taper block 30 disposed between the first clamp seat 20 and the second clamp seat 10, a taper collar 61 disposed on the taper block 30, a pair of coiled springs 40, a pair of fastening bolts 50, a pair of compression springs 41, a pair of fastening tubes 51, an adjustment bolt 60, and a nut 70.

The first clamp seat 20 has an inclined face 24, a pair of slant faces 25, a notch 26, a pressing face 21, an upper face 23, a recessed face 27, and a pair of through holes 22.

The second clamp seat 10 has an inclined face 14, a pair of slant faces 15, a notch 16, a pressing face 11, an upper face 13, a recessed face 17, and a pair of through apertures 12.

The taper block 30 has an oblong hole 35, a first taper face 33, a second taper face 32, and four corner taper faces 33.

The taper collar 61 has a center hole 62.

The coiled springs 40 are inserted in the through holes 22 of the first clamp seat 20.

The fastening bolts 50 pass through the coiled springs 40 to fasten the first clamp seat 20 and the second clamp seat 10 together.

The compression springs 41 are inserted in the through apertures 12 of the second clamp seat 10.

The fastening tubes 51 pass through the compression springs 41 to fasten the first clamp seat 20 and the second clamp seat 10 together.

The fastening bolts 50 engage with the fastening tubes 51.

The adjustment bolt 60 pass through the taper collar 61 and the taper block 30.

The nut 70 engages with the adjustment bolt 60.

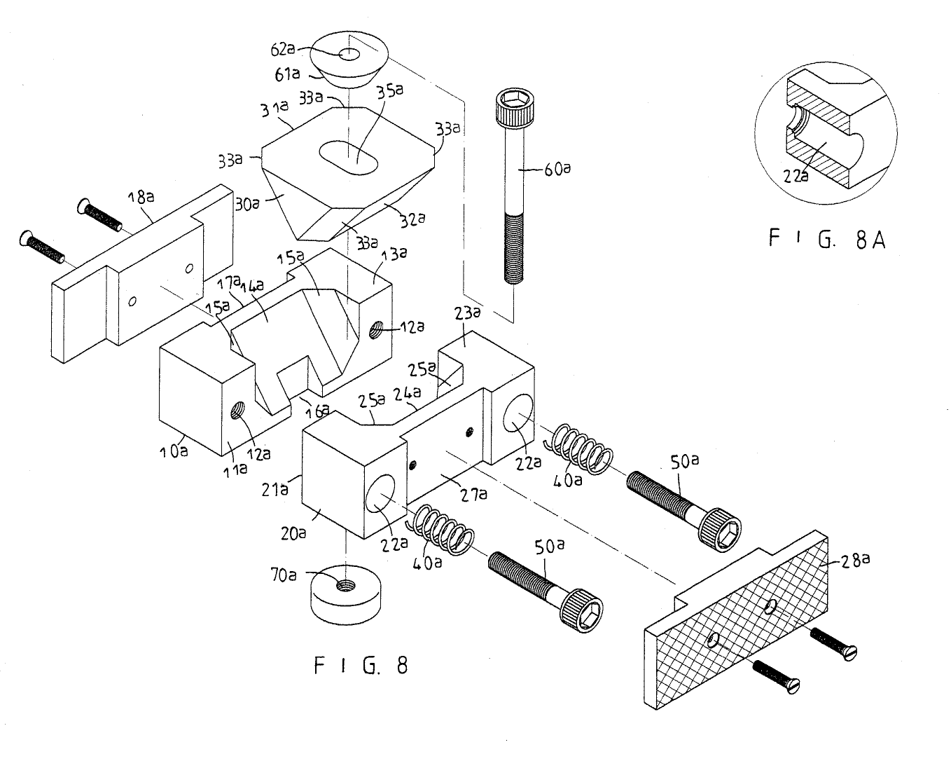

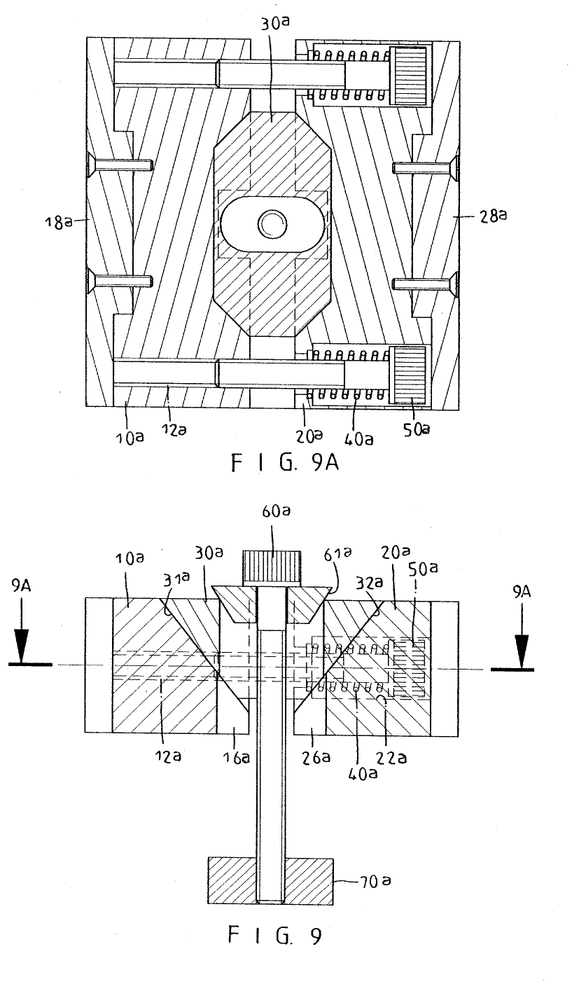

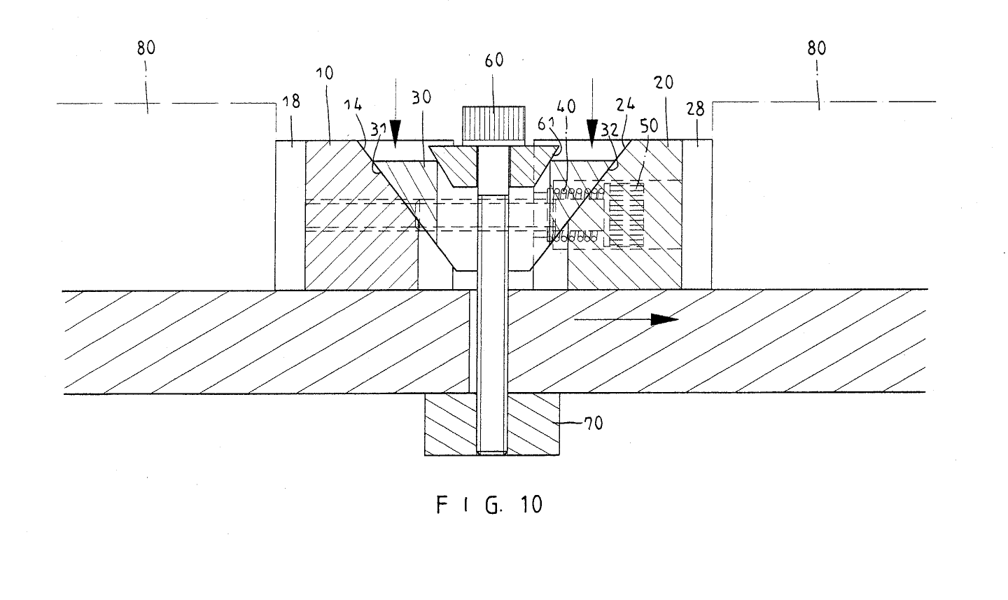

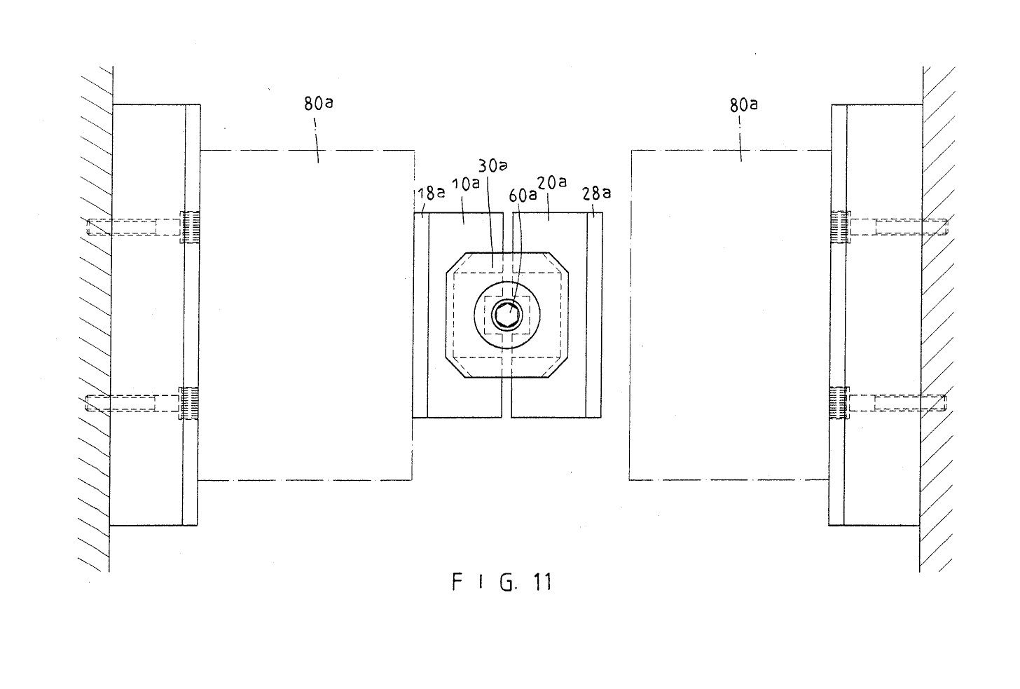

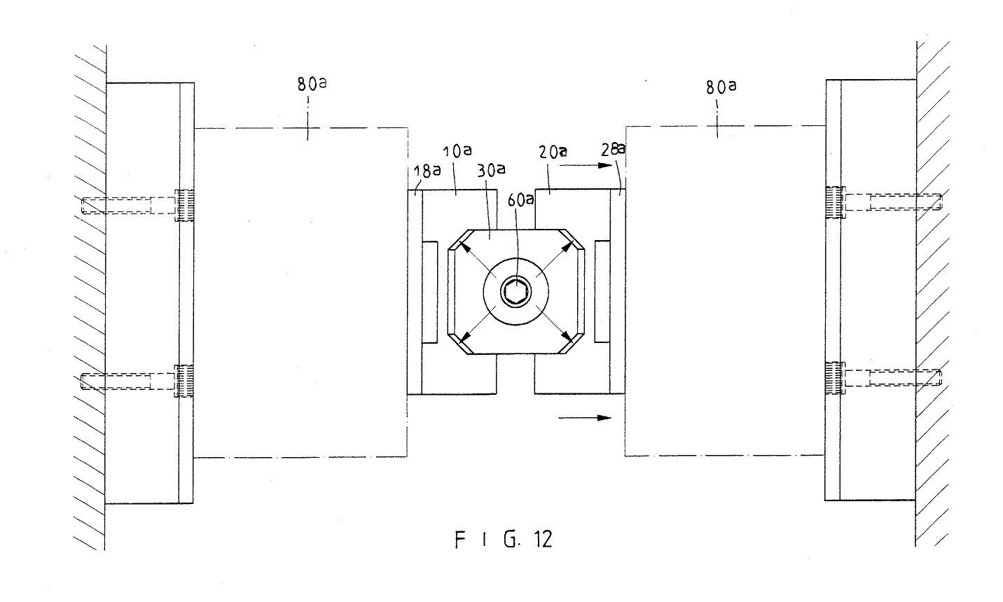

Referring to FIGS. 8 to 12, a second vise comprises a first clamp seat 20a, a second clamp seat 10a engaging with the first clamp seat 20a, a first clamp plate 28a fastened on the first clamp seat 20a, a second clamp plate 18a fastened on the second clamp seat 10a, a taper block 30a disposed between the first clamp seat 20a and the second clamp seat 10a, a taper collar 61a disposed on the taper block 30a, a pair of coiled springs 40a, a pair of fastening bolts 50a, an adjustment bolt 60a, and a nut 70a.

The first clamp seat 20a has an inclined face 24a, a pair of slant faces 25a, a notch 26a, a pressing face 21a, an upper face 23a, a recessed face 27a, and a pair of through holes 22a.

The second clamp seat 10a has an inclined face 14a, a pair of slant faces 15a, a notch 16a, a pressing face 11a, an upper face 13a, a recessed face 17a, and a pair of threaded apertures 12a.

The taper block 30a has an oblong hole 35a, a first taper face 33a, a second taper face 32a, and four corner taper faces 33a.

The taper collar 61a has a center hole 62a.

The coiled springs 40a are inserted in the through holes 22a of the first clamp seat 20a.

The fastening bolts 50a pass through the coiled springs 40a to fasten the first clamp seat 20a and the second clamp seat 10a together.

The adjustment bolt 60a pass through the taper collar 61a and the taper block 30a.

The nut 70a engages with the adjustment bolt 60a.

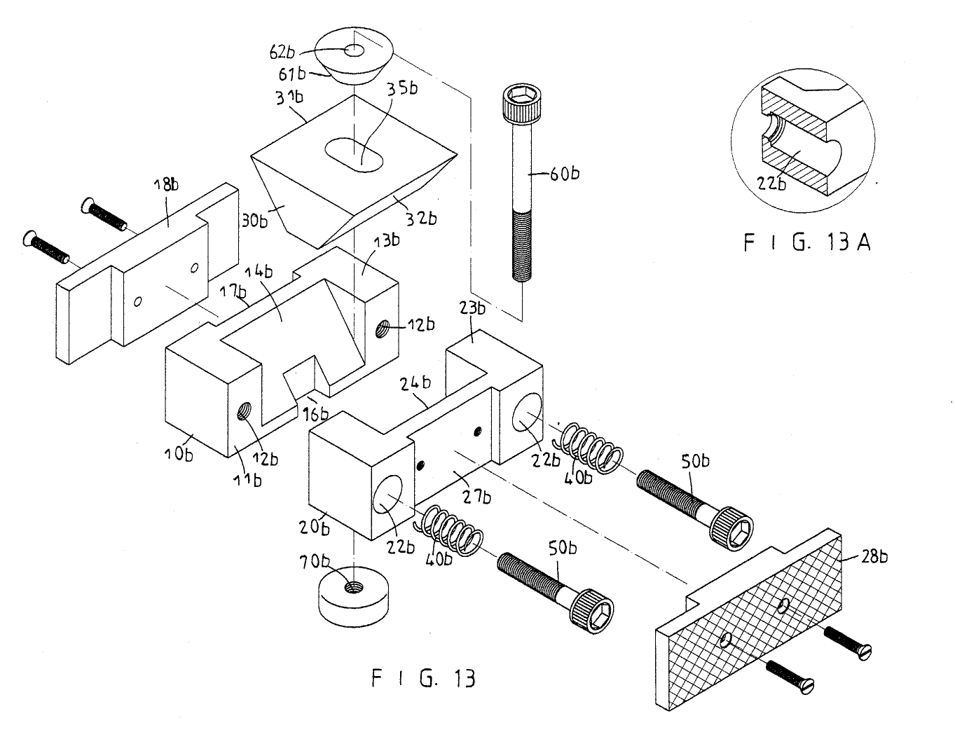

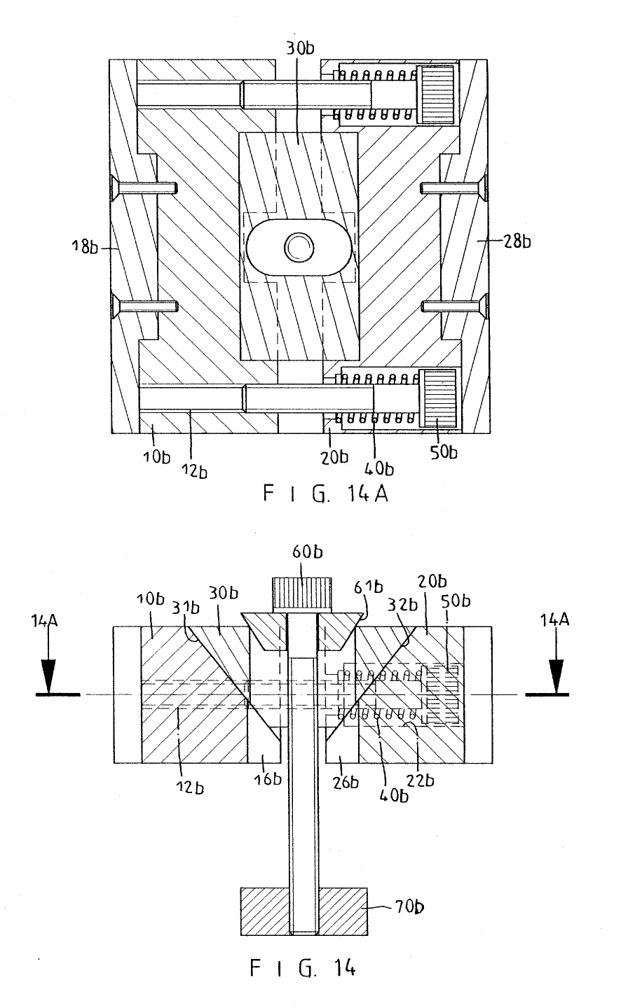

Referring to FIGS. 13, 13A, 14 and 14A, a third vise comprises a first clamp seat 20b, a second clamp seat 10b engaging with the first clamp seat 20b, a first clamp plate 28b fastened on the first clamp seat 20b, a second clamp plate 18b fastened on the second clamp seat 10b, a taper block 30b disposed between the first clamp seat 20b and the second clamp seat 10b, a taper collar 61b disposed on the taper block 30b, a pair of coiled springs 40b, a pair of fastening bolts 50b, an adjustment bolt 60b, and a nut 70b.

The first clamp seat 20b has an inclined face 24b, a notch 26b, a pressing face 21b, an upper face 23b, a recessed face 27b, and a pair of through holes 22b.

The second clamp seat 10b has an inclined face 14b, a notch 16b, a pressing face 10b, an upper face 13b, a recessed face 17b, and a pair of threaded apertures 12b.

The taper block 30b has an oblong hole 35b, a first taper face 33b, a second taper face 32b, and four corner taper faces 33b.

The taper collar 61b has a center hole 62b.

The coiled springs 40b are inserted in the through holes 22b of the first clamp seat 20b.

The fastening bolts 50b pass through the coiled springs 40b to fasten the first clamp seat 20b and the second clamp seat 10b together.

The adjustment bolt 60b pass through the taper collar 61b and the taper block 30b.

The nut 70b engages with the adjustment bolt 60b.

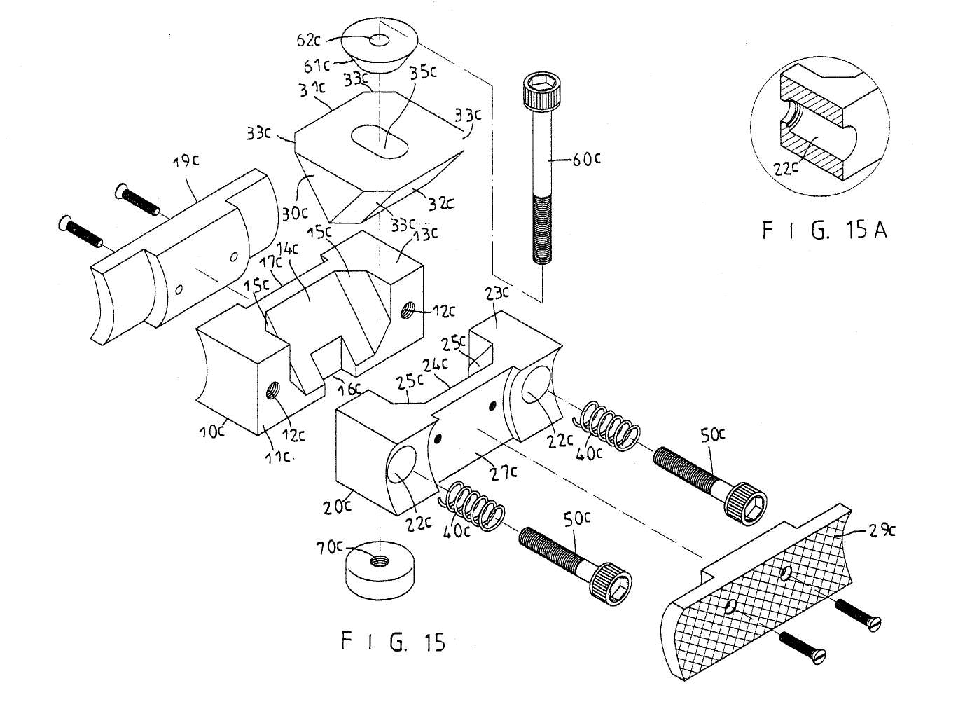

Referring to FIG. 15, a fourth vise comprises a first clamp seat 20c, a second clamp seat 10c engaging with the first clamp seat 20c, a first camber plate 29c fastened on the first clamp seat 20c, a second camber plate 19c fastened on the second clamp seat 10c, a taper block 30c disposed between the first clamp seat 20c and the second clamp seat 10c, a taper collar 61c disposed on the taper block 30c, a pair of coiled springs 40c, a pair of fastening bolts 50c, a pair of compression springs 41c, a pair of fastening tubes 51c, an adjustment bolt 60c, and a nut 70c.

The first clamp seat 20c has an inclined face 24c, a pair of slant faces 25c, a notch 26c, a pressing face 21c, an upper face 23c, a camber recess 27c, and a pair of through holes 22c.

The second clamp seat 10c has an inclined face 14c, a pair of slant faces 15c, a notch 16c, a pressing face 11c, an upper face 13c, a camber recess 17c, and a pair of threaded apertures 12c.

The taper block 30c has an oblong hole 35c, a first taper face 33c, a second taper face 32c, and four corner taper faces 33c.

The taper collar 61c has a center hole 62c.

The coiled springs 40c are inserted in the through holes 22c of the first clamp seat 20c.

The fastening bolts 50c pass through the coiled springs 40c to fasten the first clamp seat 20c and the second clamp seat 10c together.

The adjustment bolt 60c pass through the taper collar 61c and the taper block 30c.

The nut 70c engages with the adjustment bolt 60c.

The present invention is not limited to the above embodiments but various modification thereof may be made. Furthermore, various changes in form and detail may be made without departing from the scope of the present invention.

I claim:

1. A vise comprises:
a first clamp seat,
a second clamp seat engaging with the first clamp seat,
a first clamp plate fastened on the first clamp seat,
a second clamp plate fastened on the second clamp seat,
a taper block disposed between the first clamp seat and the second clamp seat,
a taper collar disposed on the taper block,
a pair of coiled springs inserted in the first clamp seat,
a pair of fastening bolts passing through the coiled springs to fasten the first clamp seat and the second clamp seat together,
an adjustment bolt passing through the taper collar and the taper block, and
a nut engaging with the adjustment bolt.

2. The vise as claimed in claim 1, wherein the first clamp seat has an inclined face, a notch, a recessed face, and a pair of through holes.

3. The vise as claimed in claim 1, wherein the second clamp seat has an inclined face, a notch, a recessed face, and a pair of threaded apertures.

4. The vise as claimed in claim 1, wherein the taper block has an oblong hole.

5. The vise as claimed in claim 1, wherein the taper collar has a center hole.

6. The vise as claimed in claim 2, wherein the coiled springs are inserted in the through holes of the first clamp seat.

7. The vise as claimed in claim 6, wherein the fastening bolts pass through the coiled springs to fasten the first clamp seat and the second clamp seat together.

8. The vise as claimed in claim 1, wherein the The adjustment bolt pass through the taper collar and the taper block.

9. The vise as claimed in claim 8, wherein the nut engages with the adjustment bolt.
